(19) United States
(12) Patent Application Publication
(10) Pub. No.: US 2025/0386034 A1
(43) Pub. Date: Dec. 18, 2025

(54) CROSS-COMPONENT PREDICTION

(71) Applicant: Tencent America LLC, Palo Alto, CA (US)

(72) Inventors: Lien-Fei CHEN, Palo Alto, CA (US); Madhu PERINGASSERY KRISHNAN, Mountain View, CA (US); Biao WANG, San Jose, CA (US); Roman CHERNYAK, Santa Clara, CA (US); Xin ZHAO, San Jose, CA (US); Shan LIU, San Jose, CA (US)

(73) Assignee: Tencent America LLC, Palo Alto, CA (US)

(21) Appl. No.: 19/303,116

(22) Filed: Aug. 18, 2025

Related U.S. Application Data
(63) Continuation of application No. PCT/US2024/032452, filed on Jun. 4, 2024.
(60) Provisional application No. 63/528,589, filed on Jul. 24, 2023.

(51) Int. Cl. H04N 19/159; H04N 19/176; H04N 19/186

(52) U.S. Cl. CPC H04N 19/159; H04N 19/176; H04N 19/186

(57) ABSTRACT

In a method, a first chroma prediction block of a chroma block of a current block is determined based on an inter prediction mode. A second chroma prediction block of the chroma block of the current block is determined based on a cross-component prediction mode in which the second chroma prediction block is derived based on reconstructed luma samples of a luma block of the current block. A prediction block of the chroma block is determined as a weighted average of the first chroma prediction block of a plurality of chroma prediction blocks and the second chroma prediction block of the plurality of chroma prediction blocks. A first syntax element is encoded in a bitstream that indicates the chroma block of the current block is predicted by the weighted average of the plurality of chroma prediction blocks.

### INCORPORATION BY REFERENCE

The present application is a continuation of International Application No. PCT/US2024/032452, filed on Jun. 4, 2024, which claims the benefit of priority to U.S. Provisional Application No. 63/528,589, filed on Jul. 24, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of processing visual media data is provided. In the method, a bitstream of the visual media data is processed according to a format rule. In an example, the bitstream includes a first syntax element associated with a current block in a current picture. The current block includes a chroma block and a luma block. The first syntax element indicates whether the chroma block is predicted by a weighted average of a plurality of chroma prediction blocks. The format rule specifies that, when the first syntax element indicates that the chroma block is predicted by the weighted average of the plurality of chroma prediction blocks, a first chroma prediction block of the plurality of chroma prediction blocks is determined based on an inter prediction mode. A second chroma prediction block of the plurality of chroma prediction blocks is determined based on a cross-component prediction mode in which the second chroma prediction block is derived based on reconstructed luma samples of the luma block that are filtered according to filter coefficients of a filter. The filter coefficients of the filter are derived based on (i) a chroma prediction of the chroma block and a luma prediction of the luma block or (ii) a merge candidate in a merge list that is coded in the cross-component prediction mode. The format rule specifies that a prediction block of the chroma block is determined as a weighted average of the first chroma prediction block and the second chroma prediction block.

In an example, when both a top neighboring block and a left neighboring block of the current block are coded in the cross-component prediction mode, a weight of the second chroma prediction block in the weighted average is 0.75. When at least one of the top neighboring block and the left neighboring block of the current block is coded in the cross-component prediction mode, the weight of the second chroma prediction block in the weighted average is 0.5. When none of the top neighboring block and the left neighboring block of the current block is coded in the cross-component prediction mode, the weight of the second chroma prediction block in the weighted average is 0.25.

In an example, the format rule specifies that the merge list is constructed based on a plurality of cross-component prediction coded blocks that includes at least one of (i) an adjacent spatial neighboring block, (ii) a non-adjacent spatial neighboring block, (iii) a history-based neighboring block, (iv) a temporal collocated block, and (v) a temporal shifted block in a reference picture of the current picture.

According to another aspect of the disclosure, a method of video encoding is provided. In the method, a first chroma prediction block of a chroma block of a current block is determined based on an inter prediction mode. A second chroma prediction block of the chroma block of the current block is determined based on a cross-component prediction mode in which the second chroma prediction block is derived based on reconstructed luma samples of a luma block of the current block. A prediction block of the chroma block is determined as a weighted average of the first chroma prediction block of a plurality of chroma prediction blocks and the second chroma prediction block of the plurality of chroma prediction blocks. A first syntax element is encoded in a bitstream that indicates the chroma block of the current block is predicted by the weighted average of the plurality of chroma prediction blocks.

In an example, the cross-component prediction mode includes a first cross-component prediction mode in which the second chroma prediction block is derived based on the reconstructed luma samples of the luma block that are filtered according to filter coefficients of a first filter. The filter coefficients of the first filter are derived based on a chroma prediction of the chroma block and a luma prediction of the luma block. The cross-component prediction mode includes a second cross-component prediction mode in which the second chroma prediction block is derived based on the reconstructed luma samples of the luma block that are filtered by filter coefficients of a second filter. The filter coefficients of the second filter are derived based on a merge candidate in a merge list.

In an example, when both a top neighboring block and a left neighboring block of the current block are coded in the cross-component prediction mode, a weight of the second chroma prediction block in the weighted average is 0.75. When at least one of the top neighboring block and the left neighboring block of the current block is coded in the cross-component prediction mode, the weight of the second chroma prediction block in the weighted average is 0.5. When none of the top neighboring block and the left neighboring block of the current block is coded in the cross-component prediction mode, the weight of the second chroma prediction block in the weighted average is 0.25.

According to yet another aspect of the disclosure, an apparatus of video decoding is provided. The apparatus includes processing circuitry. The processing circuitry is configured to receive a bitstream including a first syntax element associated with a current block in a current picture. The current block includes a chroma block and a luma block. The first syntax element indicates whether the chroma block is predicted by a weighted average of a plurality of chroma prediction blocks. When the first syntax element indicates that the chroma block is predicted by the weighted average of the plurality of chroma prediction blocks, the processing circuitry is configured to determine (i) a first chroma prediction block of the plurality of chroma prediction blocks based on an inter prediction mode and (ii) a second chroma prediction block of the plurality of chroma prediction blocks based on a cross-component prediction mode in which the second chroma prediction block is derived based on reconstructed luma samples of the luma block. The processing circuitry is configured to determine a prediction block of the chroma block as a weighted average of the first chroma prediction block and the second chroma prediction block.

In an example, the cross-component prediction mode includes a first cross-component prediction mode in which the second chroma prediction block is derived based on the reconstructed luma samples of the luma block that are filtered according to filter coefficients of a first filter. The filter coefficients of the first filter are derived based on a chroma prediction of the chroma block and a luma prediction of the luma block. The cross-component prediction mode includes a second cross-component prediction mode in which the second chroma prediction block is derived based on the reconstructed luma samples of the luma block that are filtered by filter coefficients of a second filter. The filter coefficients of the second filter are derived based on a merge candidate in a merge list.

In an example, the first syntax element is signaled in the bitstream when the cross-component prediction mode is applied to the current block.

In an example, the processing circuitry is configured to determine a prediction block of the luma block by copying a luma inter-prediction block when the first syntax element indicates that the chroma block is predicted by the weighted average of the plurality of chroma prediction blocks and the cross-component prediction mode is applied to the current block. In an example, the processing circuitry is configured to receive a flag in the bitstream. The flag indicates whether the luma block is predicted using a weighted average of a plurality of luma prediction blocks.

In an example, when both a top neighboring block and a left neighboring block of the current block are coded in the cross-component prediction mode, a weight of the second chroma prediction block in the weighted average is 0.75. When one of the top neighboring block and the left neighboring block of the current block is coded in the cross-component prediction mode, the weight of the second chroma prediction block in the weighted average is 0.5. When none of the top neighboring block and the left neighboring block of the current block is coded in the cross-component prediction mode, the weight of the second chroma prediction block in the weighted average is 0.25.

In an example, the processing circuitry is configured to construct the merge list based on a plurality of cross-component prediction coded blocks that includes at least one of (i) an adjacent spatial neighboring block, (ii) a non-adjacent spatial neighboring block, (iii) a history-based neighboring block, (iv) a temporal collocated block, and (v) a temporal shifted block in a reference picture of the current picture. The merge list is constructed based on a predefined scanning order of the adjacent spatial neighboring block, the history-based neighboring block, the non-adjacent spatial neighboring block, and the temporal collocated block from the reference picture.

In an example, when a second syntax element in the bitstream indicates that the merge list is used in the cross-component prediction mode, the processing circuitry is configured to determine the merge candidate from the merge list that is indicated by an index in the bitstream.

In an example, when the second syntax element indicates that the second cross-component prediction mode is not applied, the processing circuitry is configured to (i) derive the filter coefficients of the first filter based on the chroma prediction of the chroma block and the luma prediction of the luma block or (ii) determine the filter coefficients of the first filter according to signaled information in the bitstream.

In an example, the processing circuitry is configured to divide the merge list into a plurality of sub-groups. The processing circuitry is configured to determine the merge candidate from the merge list that is indicated by an index in the bitstream. The index includes a first part indicating which one of the plurality of sub-groups is selected and a second part indicating which one of merge candidates is selected from the selected sub-group.

Aspects of the disclosure also provide an apparatus for video encoding. The apparatus for video encoding includes processing circuitry configured to implement any of the described methods for video encoding.

Aspects of the disclosure also provide a method for video decoding. The method includes any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further Features, the Nature, and Various Advantages of the Disclosed Subject Matter Will be More Apparent from the Following Detailed Description and the Accompanying Drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of a weight derivation based on neighboring blocks.

FIG. 5 is a schematic illustration of a cross-component prediction without blending without a chroma predictor.

FIG. 6 is a schematic illustration of a cross-component prediction without blending with a chroma predictor.

FIG. 7 shows a flow chart outlining a decoding process according to some aspects of the disclosure.

FIG. 8 shows a flow chart outlining an encoding process according to some aspects of the disclosure.

FIG. 9 is a schematic illustration of a computer system in accordance with an aspect.

### DETAILED DESCRIPTION

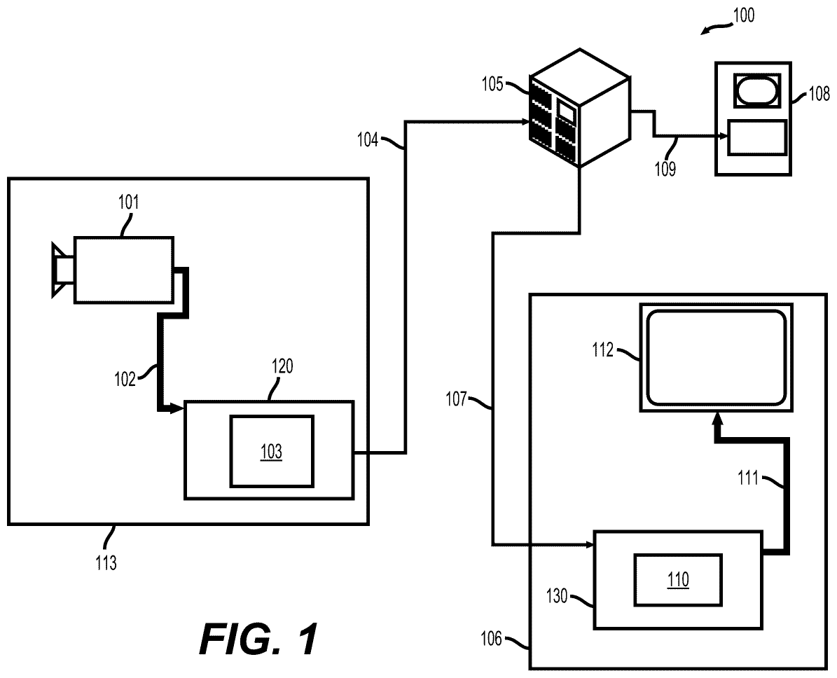

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

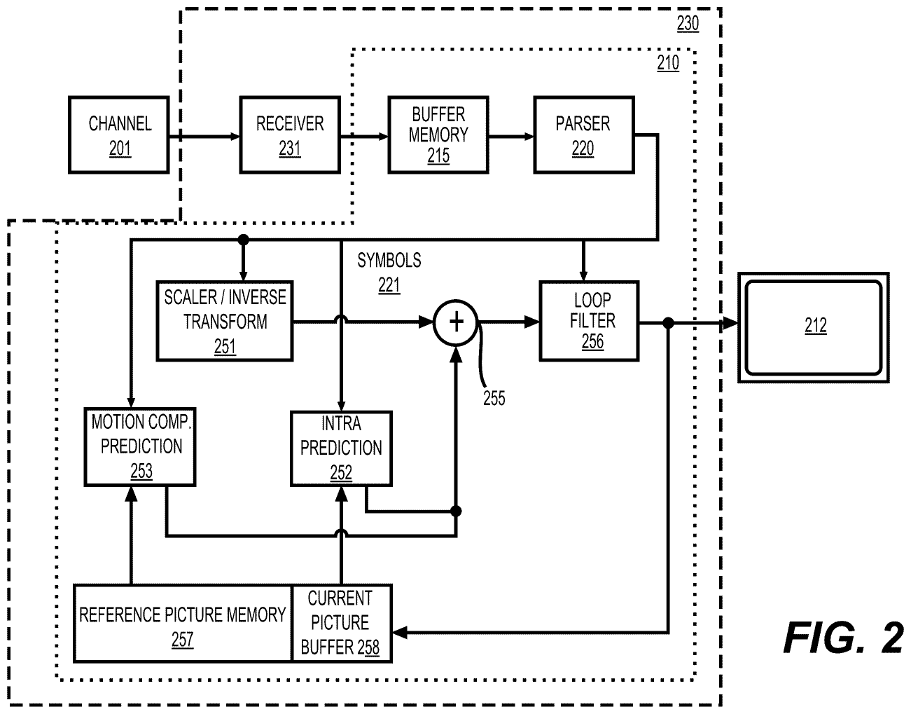

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

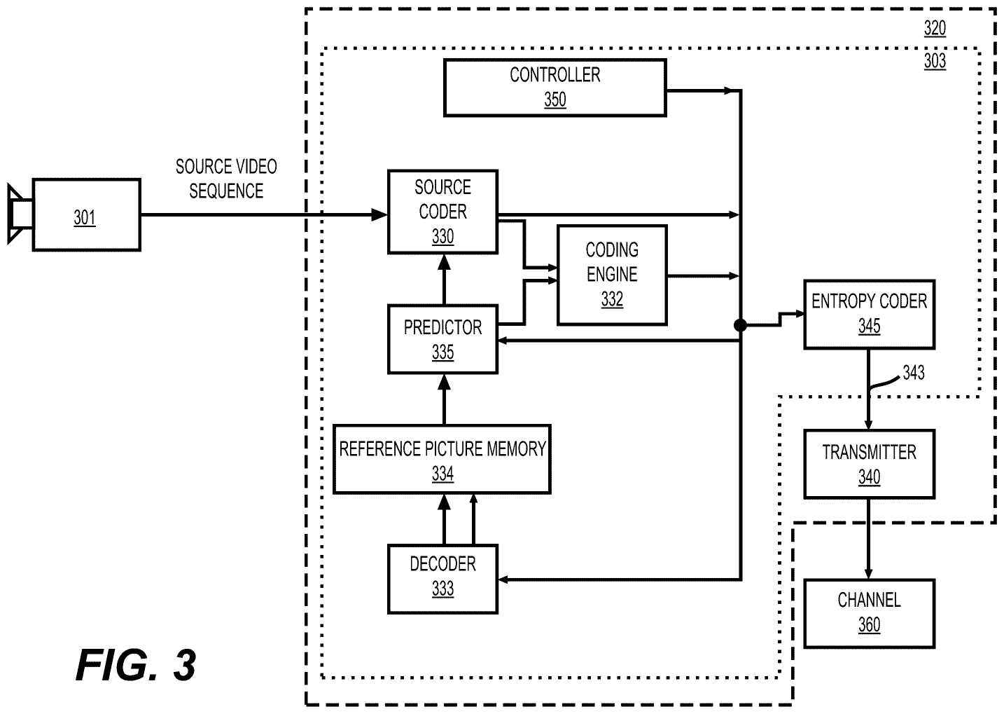

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure include techniques for improvement of cross-component prediction.

Video coding has been widely used in many applications, such as broadcasting, video recording, and video streaming. Many emerging video coding standards, such H.264, H.265/HEVC, H.266/VVC, and AV1, are published and widely adopted in these video applications. In an aspect, a hybrid video codec includes a plurality of coding modules, such as an intra prediction, an inter prediction, a transform coding, a quantization, an entropy coding, and a post in-loop filter. In the present disclosure, improvement of cross-component prediction is provided to enhance signaling and prediction of a cross-component prediction.

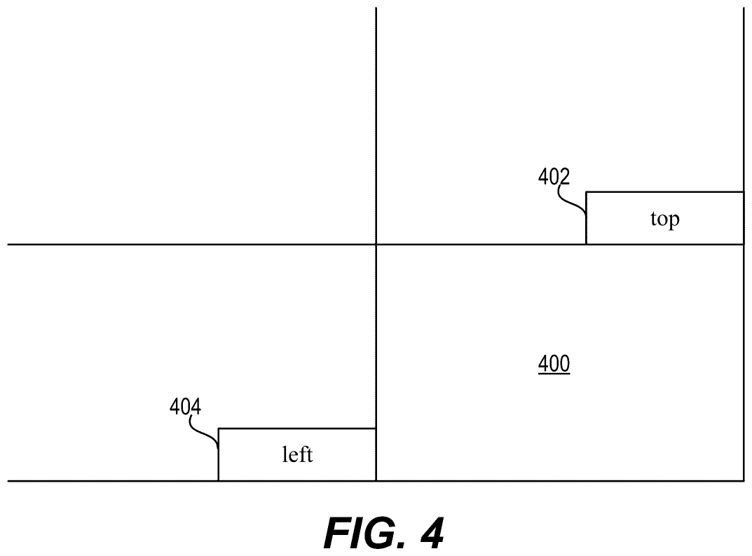

In an aspect of the disclosure, a first method is provided to combine a plurality of prediction signals, such as an inter prediction signal with an intra prediction signal. An example of the first method is described in equation 1.

$${P}_{combi} = ( 1 - ω ) \times {P}_{mode A} + ω \times {P}_{mode B} \qquad Eq . ( 1 )$$

where ω is a weight value between 0 and 1, P_{modeA} is derived using a prediction process according to a method of a mode A, and P_{modeB} is derived using a prediction process according to a method of a mode B. These two prediction samples are then combined using a weighted average value w. The weighted average value ω may be signaled or be calculated depending on coding modes of neighboring blocks, such as coding modes of a top neighboring block (402) and a left neighboring block (404) of a current block (400) shown in FIG. 4. An example of weight derivation by using the top and left neighboring blocks is shown as follows:
(1) If a top neighbor is available and coded by the mode B, then isModeBTop is set to 1, otherwise isModeBTop is set to 0;
(2) If a left neighbor is available and coded by the mode B, then isModeBLeft is set to 1, otherwise isModeBLeft is set to 0;
(3) If (isModeBLeft+isModeBTop) is equal to 2, then w is set to 0.75;
(4) Otherwise, if (isModeBLeft+isModeBTop) is equal to 1, then w is set to 0.5; and
(5) Otherwise, ω is set to 0.25.

In an aspect of the disclosure, a second method, such as an inter-block cross-component prediction (CCP) method, is provided to predict chroma samples from reconstructed luma samples when a current block is coded in an inter prediction mode by using a motion vector (MV) to point to a prediction block in a reference picture or an alternative prediction mode by using a block vector (BV) to point to a prediction block in a reconstructed picture. The BV may be explicitly signaled, inherited from a neighboring coded block, or implicitly derived by comparing a distortion cost between a template of the current coding block and a reference template within a predefined reconstructed area.

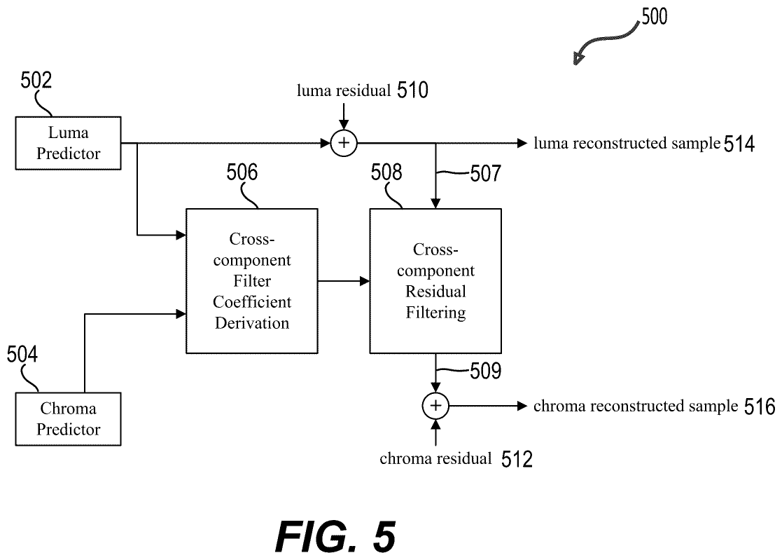

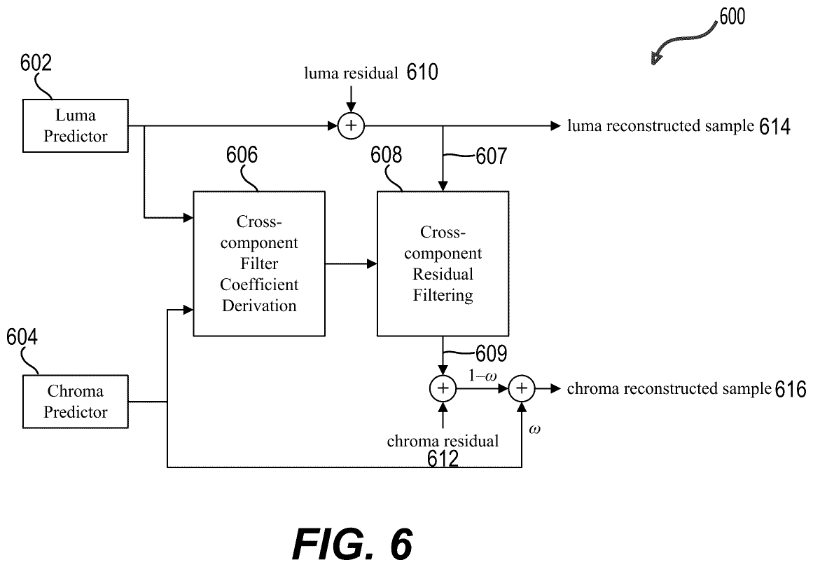

FIGS. 5 and 6 illustrate two examples of the CCP method from a decoder side. As shown in FIGS. 5 and 6, cross-component filters are derived using prediction blocks of a luma block and a chroma block. The derived filters are applied to a reconstructed luma block to predict the chroma block. FIG. 5 shows a cross-component prediction to predict a chroma prediction block without blending with a chroma predictor. FIG. 6 shows a cross-component prediction to predict a chroma prediction block with blending with a chroma predictor. In FIG. 6, the predicted chroma block may be blended with the chroma predictor using a MV or a BV to produce a final chroma prediction block.

An example of a cross-component prediction (500) for a chroma block is provided in FIG. 5. As shown in FIG. 5, a luma predictor (502) and a chroma predictor (504) of a block may be applied to derive a filter coefficient (506) of a filter, such as a cross-component filter coefficient of a cross-component filter. In an example, the luma predictor (502) and the chroma predictor (504) are obtained based on any suitable prediction modes, such as an inter prediction mode, an intra prediction mode, an intra block copy (IBC) mode, a cross-component linear model (CCLM), a multi-model linear model (MMLM), a convolutional cross-component intra prediction model (CCCM), and a gradient linear model (GLM). The cross-component filter coefficient may be derived based on any one of the cross-component modes. For example, the cross-component filter coefficient may be derived based on one of the CCLM, MMLM, CCCM, and GLM. The derived cross-component filter coefficient (506) may be further applied on a reconstructed luma block (507) to generate a predicted chroma block (509). The reconstructed luma block (507) may be determined as a sum of the luma predictor (502) and the luma residual (510). Chroma reconstructed samples (516) may be determined as a sum of the predicted chroma block (509) and a chroma residual (512). The chroma residual (512) may be a difference between the chroma block and the chroma predictor (504). Further, luma reconstructed samples (514) may be determined as a sum of the luma predictor (502) and a luma residual (510).

FIG. 6 shows an example of a cross-component prediction (600) for a chroma block in which a predicted chroma block (609) is blended with a chroma predictor (604). As shown in FIG. 6, chroma reconstructed samples (616) are determined as a weighted combination of the chroma predictor (604) and the predicted chroma block (609) based on a weighting factor w.

In an aspect of the disclosure, a third method is provided for a cross-component prediction. In the third method, a merge list is constructed and used to derive a prediction model (e.g., cross-component prediction model) by using neighboring blocks, such as (1) an adjacent spatial neighboring block, (2) a non-adjacent spatial neighboring block, (3) a history-based spatial neighboring block, (4) a temporal co-located block, and/or (5) a temporal shifted block (where a shifting motion vector is derived from neighboring blocks) from a reference picture. The cross-component prediction may include a cross-component intra prediction and an inter-block cross-component prediction. For the cross-component intra prediction, a merge list construction may be derived. For the inter-block cross-component prediction shown in the second method, a merge list construction for the second method may be constructed, such as constructed based on neighboring blocks.

In an example of the third method, filter coefficients of a filter, such as the filter coefficient (506) or (606), may be derived based on a merge candidate in the merge list. For example, when the merge candidate is coded in one of a cross-component prediction mode, such as the CCLM, the MMLM, the CCCM, and the GLM, filter coefficients derived for the merge candidate coded in the cross-component prediction mode may be applied in the cross-component prediction of the third method. Thus, the derived filter coefficient (506) in FIG. 5 and the derived filter coefficient (606) in FIG. 6 may be not needed.

In the disclosure, a combined inter and intra prediction may refer to a combined inter and intra prediction in the first method to predict a prediction sample by using a weighting average of prediction samples from two different prediction modes. An inter-block cross-component prediction (CCP) may refer to an inter-block cross-component prediction in the second method by using a prediction block to derive a cross-component prediction model and then the cross-component prediction model is applied on a luma reconstructed block to predict a chroma prediction block when the current block is coded in inter prediction or coded in a prediction mode by using a block vector (BV) to point to a prediction block in a reconstructed picture. The block vector may be explicitly signaled, inherited from a neighboring coded block, or implicitly derived by comparing a distortion cost between a template of the current coding block and a reference template within a predefined reconstructed area. A merge list may refer to a merge list construction for a cross-component prediction and the cross-component prediction may be, but is not limited to, the second method (e.g., inter-block cross-component prediction) or other existing cross-component intra predictions.

In the disclosure, a weighting average mode (or method) is provided in which a final chroma prediction block may be derived by using a weighted average of multiple chroma prediction blocks. The multiple chroma prediction blocks may be derived from one or more of the methods discussed above. A coded information, such as a first syntax element or a first flag, may be signaled to indicate whether the weighting average mode is used or not. When the first flag is true (or a first value, such as 1), it means that a weighting average of a plurality of chroma prediction blocks is applied. For example, a weighting average of (i) a chroma prediction block for a chroma component of a current block based on an inter prediction and (ii) a chroma prediction block for the chroma component based on one of the second method or the third method is applied. Otherwise, when the first flag is false (or a second value, such as 0), the weighting average method (or mode) is not applied on the current block.

In an aspect, the first flag (or first syntax) is signaled based on one or more conditions. For example, the first flag may be signaled when a prediction method, such as the second method of the third method, is applied to a current block.

In an aspect, the first flag is signaled at a coding structure level, such as a coding block level, a transform block level, or the like.

In an aspect, the second method or the third method is applied on a current block when the first flag is true (or a first value, such as 1). Accordingly, in the weighting average method indicated by the first flag, an inter prediction block may be a mode A and a prediction block based on the second method or the third method may be a mode B. A combined prediction block of the current block may be derived based on the inter prediction block and the prediction block from the second method or the third method when the second method or the third method is selected and signaled.

In an aspect, a luma prediction block of a luma component of a current block is formed by directly copying a luma inter-prediction block when the first flag is true and the second method or the third method is applied on the current block.

In an aspect, the first flag is signaled for a chroma component only. For a luma component, another syntax element or another flag is used to indicate whether the first method is used or not.

In an aspect, a weight (e.g., w) derivation depends on neighboring blocks and prediction modes of the neighboring blocks. For example, the weight may be derived based on whether a neighboring top block and/or a neighboring left block are coded in the second method.

In example, a weight of the second method is a first weight (e.g., 0.75) when both the neighboring top block and the neighboring left block are coded in the second method. In an example, the weight of the second method is a second weight (e.g.,) 0.5 when at least one of the neighboring top block and the neighboring left block is coded in the second method. In an example, the weight of the second method is a third weight (e.g., 0.25) when none of the neighboring top block and the neighboring left block is coded in the second method.

In an aspect, the weight derivation depends on whether the neighboring top block and the neighboring left block are coded in the third method.

In an example, the weight of the third method is 0.75 when both of the neighboring top block and the neighboring left block are coded in the third method. In an example, the weight of the third method is 0.5 when at least one of the neighboring top block and the neighboring left block is coded in the third method. In an example, the weight of the third method is 0.25 when none of the neighboring top block and the neighboring left block is coded in the third method.

In an aspect, the weight derivation depends on whether the neighboring top and left blocks are coded as the second method or the third method.

In an example, the weight of the second method or the third method is 0.75 when both of the neighboring top block and the neighboring left block are coded either in the second method or the third method. In an example, the weight of the second method or the third method is 0.5 when at least one of the neighboring top block and the neighboring left block is coded either in the second method or the third method. In an example, the weight of the second method or the third method is 0.25 when none of the neighboring top block and the neighboring left block is coded either in the second method or the third method.

In the disclosure, a second list, such as a merge list, may be constructed for a cross-component prediction mode. The cross-component prediction mode may include but is not limited to the cross-component intra prediction and the inter-block cross-component prediction. The merge list may be constructed by cross-component prediction coded blocks. The cross-component prediction code block may include (1) an adjacent spatial neighboring block, (2) a non-adjacent spatial neighboring block, (3) a history-based neighboring block, (4) a temporal co-located block, and/or (5) a temporal shifted block (where a shifting motion vector is derived from neighboring blocks) in a reference picture. In an example, the cross-component prediction coded block is coded in any suitable cross-component intra predictions or inter-block cross-component predictions according to the second method. In an example, the cross-component prediction coded block is coded in one of a cross-component prediction mode, such as the CCLM, the MMLM, the CCCM, and the GLM. In an example, filter coefficients derived for the cross-component prediction coded block may be applied to the cross-component prediction of a current block.

In an aspect, coded information, such as a second syntax element or a second flag, is signaled to indicate whether the second list (or the merge list) is used or not. For example, the second flag can indicate whether the second list is used to derive filter coefficients of the cross-component prediction of the current block. If the second flag is true (or a first value, such as 1), the second list is used, and then another syntax element, such as an index, may be signaled to indicate which candidate in the second list is selected. Accordingly, a current block may be predicted based on a cross-component prediction that includes filter coefficients copied (or derived) from the selected candidate in the merge list. Otherwise, when the second flag is false (or a second value, such as 0), a derived and/or signaled cross-component prediction may be used for the current block. In an example, the derived cross-component prediction is a cross-component prediction shown in FIGS. 5 and 6, where filter coefficients of the cross-component prediction are derived based on a chroma predictor and a luma predictor.

In an aspect, the second list is constructed in a predefined scanning order based on candidates as follows: an adjacent spatial neighboring coded block, a history-based neighboring coded block, a non-adjacent spatial neighboring coded block, and/or a temporal collocated coded block from a reference picture.

For example, the adjacent spatial neighboring coded block is scanned (or identified) at first. If the adjacent spatial neighboring coded block is available, the adjacent spatial neighboring coded block is filled in the merge list. Subsequently, the history-based neighboring coded block is inserted if the history information is not empty. Further, availability of the non-adjacent spatial neighboring coded block is checked, and availability of the temporal collocated coded block is checked from the reference frame consequently.

In an aspect, candidates in the second list are reordered. The reordering may be performed according to a standard or other criteria. For example, the candidates may be reordered based on a cost of template matching of the respective candidate in an ascending order. In an example, a prediction parameter (e.g., filter coefficient) of each candidate is applied on the template of the candidate to calculate the template matching cost.

In an aspect, after the merge list is constructed, the second list (or merge list) is divided into a plurality of groups, such as N groups, where N is a non-negative number. The index described above may be split into two syntax elements (or two syntax parts): one index part may indicate a group ID of the N groups, with a range of (0, N-1), and the other index part may indicate an index (or position) of a selected candidate in the group identified by the group ID.

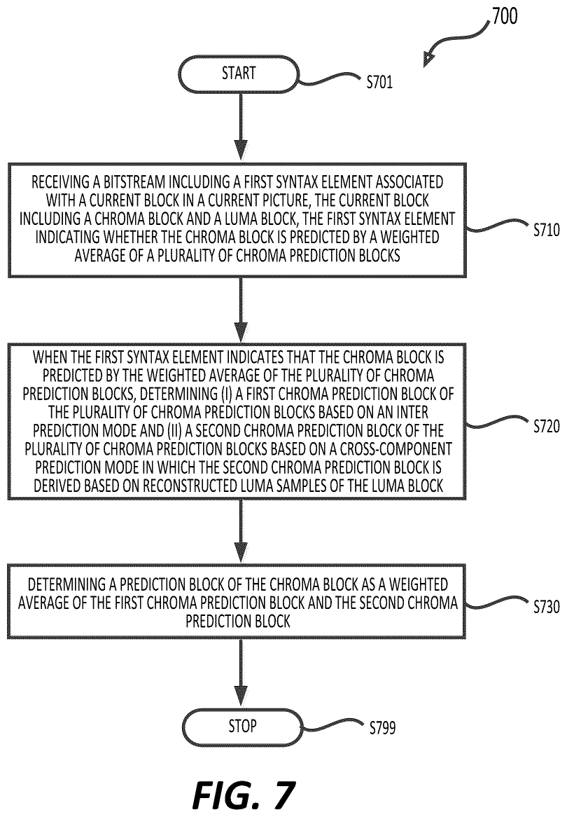

FIG. 7 shows a flow chart outlining a process (700) according to an aspect of the disclosure. The process (700) can be used in a video decoder. In various aspects, the process (700) is executed by processing circuitry, such as the processing circuitry that performs functions of the video decoder (110), the processing circuitry that performs functions of the video decoder (210), and the like. In some aspects, the process (700) is implemented in software instructions, thus when the processing circuitry executes the software instructions, the processing circuitry performs the process (700). The process starts at (S701) and proceeds to (S710).

At (S710), a bitstream including a first syntax element associated with a current block in a current picture is received. The current block includes a chroma block and a luma block. The first syntax element indicates whether the chroma block is predicted by a weighted average of a plurality of chroma prediction blocks.

At (S720), when the first syntax element indicates that the chroma block is predicted by the weighted average of the plurality of chroma prediction blocks, a first chroma prediction block of the plurality of chroma prediction blocks is determined based on an inter prediction mode. A second chroma prediction block of the plurality of chroma prediction blocks is determined based on a cross-component prediction mode in which the second chroma prediction block is derived based on reconstructed luma samples of the luma block.

At (S730), a prediction block of the chroma block is determined as a weighted average of the first chroma prediction block and the second chroma prediction block.

In an example, the cross-component prediction mode includes a first cross-component prediction mode in which the second chroma prediction block is derived based on the reconstructed luma samples of the luma block that are filtered according to filter coefficients of a first filter. The filter coefficients of the first filter are derived based on a chroma prediction of the chroma block and a luma prediction of the luma block. The cross-component prediction mode includes a second cross-component prediction mode in which the second chroma prediction block is derived based on the reconstructed luma samples of the luma block that are filtered by filter coefficients of a second filter. The filter coefficients of the second filter are derived based on a merge candidate in a merge list.

In an example, the first syntax element is signaled in the bitstream when the cross-component prediction mode is applied to the current block.

In an example, a prediction block of the luma block is determined by copying a luma inter-prediction block when the first syntax element indicates that the chroma block is predicted by the weighted average of the plurality of chroma prediction blocks and the cross-component prediction mode is applied to the current block. In an example, a flag in the bitstream is received. The flag indicates whether the luma block is predicted using a weighted average of a plurality of luma prediction blocks.

In an example, when both a top neighboring block and a left neighboring block of the current block are coded in the cross-component prediction mode, a weight of the second chroma prediction block in the weighted average is 0.75. When one of the top neighboring block and the left neighboring block of the current block is coded in the cross-component prediction mode, the weight of the second chroma prediction block in the weighted average is 0.5. When none of the top neighboring block and the left neighboring block of the current block is coded in the cross-component prediction mode, the weight of the second chroma prediction block in the weighted average is 0.25.

In an example, the merge list is constructed based on a plurality of cross-component prediction coded blocks that includes at least one of (i) an adjacent spatial neighboring block, (ii) a non-adjacent spatial neighboring block, (iii) a history-based neighboring block, (iv) a temporal collocated block, and (v) a temporal shifted block in a reference picture of the current picture. The merge list is constructed based on a predefined scanning order of the adjacent spatial neighboring block, the history-based neighboring block, the non-adjacent spatial neighboring block, and the temporal collocated block from the reference picture.

In an example, when a second syntax element in the bitstream indicates that the merge list is used in the cross-component prediction mode, the merge candidate is determined from the merge list according to an index in the bitstream.

In an example, when the second syntax element indicates that the second cross-component prediction mode is not applied, the filter coefficients of the first filter are derived based on the chroma prediction of the chroma block and the luma prediction of the luma block or the filter coefficients of the first filter are determined according to signaled information in the bitstream.

In an example, the merge list is divided into a plurality of sub-groups. The merge candidate is determined from the merge list according to an index in the bitstream. The index includes a first part indicating which one of the plurality of sub-groups is selected and a second part indicating which one of merge candidates is selected from the selected sub-group.

Then, the process proceeds to (S799) and terminates.

The process (700) can be suitably adapted. Step(s) in the process (700) can be modified and/or omitted. Additional step(s) can be added. Any suitable order of implementation can be used.

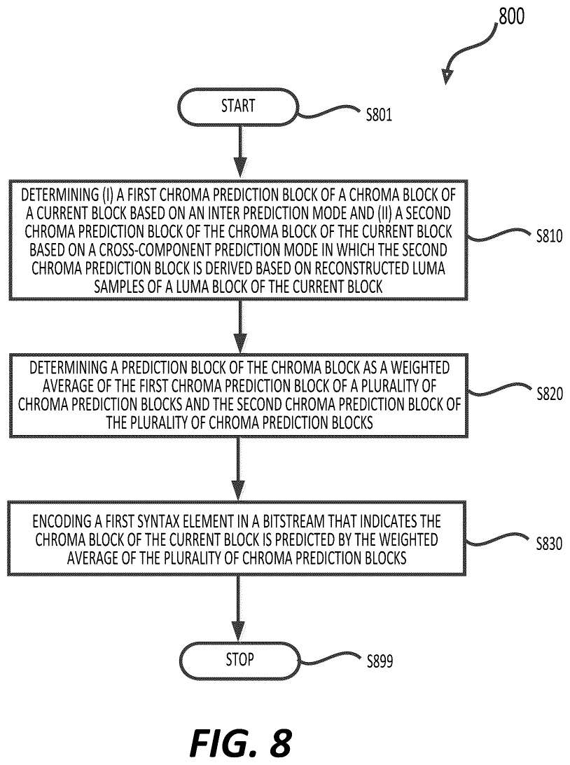

FIG. 8 shows a flow chart outlining a process (800) according to an aspect of the disclosure. The process (800) can be used in a video encoder. In various aspects, the process (800) is executed by processing circuitry, such as the processing circuitry that performs functions of the video encoder (103), the processing circuitry that performs functions of the video encoder (303), and the like. In some aspects, the process (800) is implemented in software instructions, thus when the processing circuitry executes the software instructions, the processing circuitry performs the process (800). The process starts at (S801) and proceeds to (S810).

At (S810), a first chroma prediction block of a chroma block of a current block is determined based on an inter prediction mode. A second chroma prediction block of the chroma block of the current block is determined based on a cross-component prediction mode in which the second chroma prediction block is derived based on reconstructed luma samples of a luma block of the current block.

At (S820), a prediction block of the chroma block is determined as a weighted average of the first chroma prediction block of a plurality of chroma prediction blocks and the second chroma prediction block of the plurality of chroma prediction blocks.

At (S830), a first syntax element is encoded in a bitstream that indicates the chroma block of the current block is predicted by the weighted average of the plurality of chroma prediction blocks.

In an example, the cross-component prediction mode includes a first cross-component prediction mode in which the second chroma prediction block is derived based on the reconstructed luma samples of the luma block that are filtered according to filter coefficients of a first filter. The filter coefficients of the first filter are derived based on a chroma prediction of the chroma block and a luma prediction of the luma block. The cross-component prediction mode includes a second cross-component prediction mode in which the second chroma prediction block is derived based on the reconstructed luma samples of the luma block that are filtered by filter coefficients of a second filter. The filter coefficients of the second filter are derived based on a merge candidate in a merge list.

In an example, when both a top neighboring block and a left neighboring block of the current block are coded in the cross-component prediction mode, a weight of the second chroma prediction block in the weighted average is 0.75. When at least one of the top neighboring block and the left neighboring block of the current block is coded in the cross-component prediction mode, the weight of the second chroma prediction block in the weighted average is 0.5. When none of the top neighboring block and the left neighboring block of the current block is coded in the cross-component prediction mode, the weight of the second chroma prediction block in the weighted average is 0.25.

Then, the process proceeds to (S899) and terminates.

The process (800) can be suitably adapted. Step(s) in the process (800) can be modified and/or omitted. Additional step(s) can be added. Any suitable order of implementation can be used.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes a first syntax element associated with a current block in a current picture. The current block includes a chroma block and a luma block. The first syntax element indicates whether the chroma block is predicted by a weighted average of a plurality of chroma prediction blocks. The format rule specifies that, when the first syntax element indicates that the chroma block is predicted by the weighted average of the plurality of chroma prediction blocks, a first chroma prediction block of the plurality of chroma prediction blocks is determined based on an inter prediction mode. A second chroma prediction block of the plurality of chroma prediction blocks is determined based on a cross-component prediction mode in which the second chroma prediction block is derived based on reconstructed luma samples of the luma block that are filtered according to filter coefficients of a filter. The filter coefficients of the filter are derived based on (i) a chroma prediction of the chroma block and a luma prediction of the luma block or (ii) a merge candidate in a merge list that is coded in the cross-component prediction mode. The format rule specifies that a prediction block of the chroma block is determined as a weighted average of the first chroma prediction block and the second chroma prediction block.

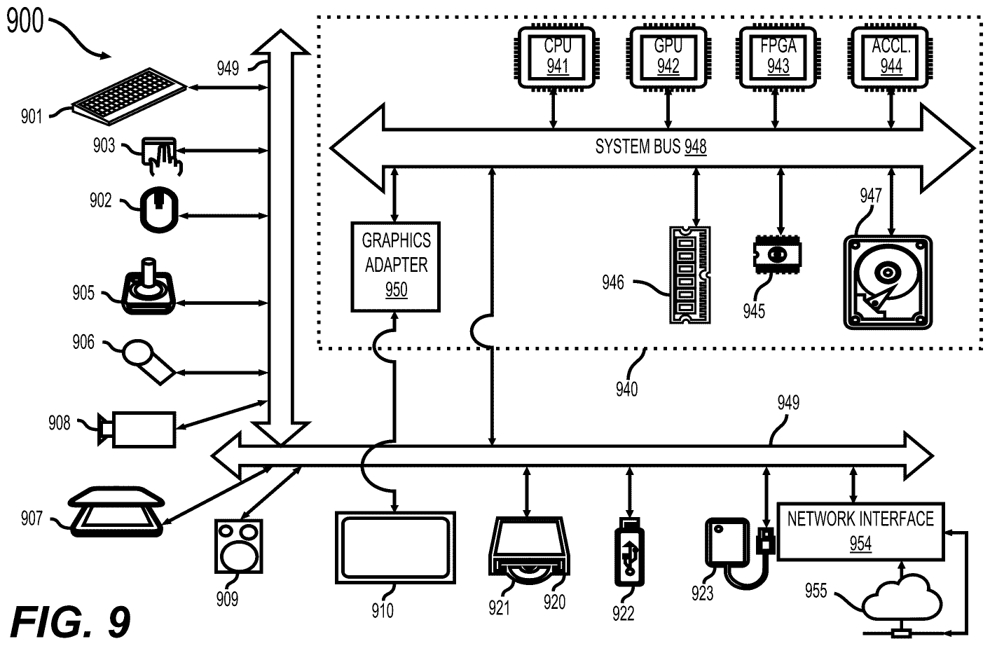

The techniques described above, can be implemented as computer software using computer-readable instructions and physically stored in one or more computer-readable media. For example, FIG. 9 shows a computer system (900) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 9 for computer system (900) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (900).

Computer system (900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (901), mouse (902), trackpad (903), touch screen (910), data-glove (not shown), joystick (905), microphone (906), scanner (907), camera (908).

Computer system (900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (910), data-glove (not shown), or joystick (905), but there can also be tactile feedback devices that do not serve as input devices), audio output devices (such as: speakers (909), headphones (not depicted)), visual output devices (such as screens (910) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (900) can also include human accessible storage devices and their associated media such as optical media including CD/DVD ROM/RW (920) with CD/DVD or the like media (921), thumb-drive (922), removable hard drive or solid state drive (923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (900) can also include an interface (954) to one or more communication networks (955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (949) (such as, for example USB ports of the computer system (900)); others are commonly integrated into the core of the computer system (900) by attachment to a system bus as described below (for example Ethernet interface into a PC computer system or cellular network interface into a smartphone computer system). Using any of these networks, computer system (900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (940) of the computer system (900).

The core (940) can include one or more Central Processing Units (CPU) (941), Graphics Processing Units (GPU) (942), specialized programmable processing units in the form of Field Programmable Gate Areas (FPGA) (943), hardware accelerators for certain tasks (944), graphics adapters (950), and so forth. These devices, along with Read-only memory (ROM) (945), Random-access memory (946), internal mass storage such as internal non-user accessible hard drives, SSDs, and the like (947), may be connected through a system bus (948). In some computer systems, the system bus (948) can be accessible in the form of one or more physical plugs to enable extensions by additional CPUs, GPU, and the like. The peripheral devices can be attached either directly to the core's system bus (948), or through a peripheral bus (949). In an example, the screen (910) can be connected to the graphics adapter (950). Architectures for a peripheral bus include PCI, USB, and the like.

CPUs (941), GPUs (942), FPGAs (943), and accelerators (944) can execute certain instructions that, in combination, can make up the aforementioned computer code. That computer code can be stored in ROM (945) or RAM (946). Transitional data can also be stored in RAM (946), whereas permanent data can be stored for example, in the internal mass storage (947). Fast storage and retrieve to any of the memory devices can be enabled through the use of cache memory, that can be closely associated with one or more CPU (941), GPU (942), mass storage (947), ROM (945), RAM (946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (900), and specifically the core (940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (940) that are of non-transitory nature, such as core-internal mass storage (947) or ROM (945). The software implementing various aspects of the present disclosure can be stored in such devices and executed by core (940). A computer-readable medium can include one or more memory devices or chips, according to particular needs. The software can cause the core (940) and specifically the processors therein (including CPU, GPU, FPGA, and the like) to execute particular processes or particular parts of particular processes described herein, including defining data structures stored in RAM (946) and modifying such data structures according to the processes defined by the software. In addition or as an alternative, the computer system can provide functionality as a result of logic hardwired or otherwise embodied in a circuit (for example: accelerator (944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding, the method comprising:
receiving a bitstream including a first syntax element associated with a current block in a current picture, the current block including a chroma block and a luma block, the first syntax element indicating whether the chroma block is predicted by a weighted average of a plurality of chroma prediction blocks;
when the first syntax element indicates that the chroma block is predicted by the weighted average of the plurality of chroma prediction blocks,
determining (i) a first chroma prediction block of the plurality of chroma prediction blocks based on an inter prediction mode and (ii) a second chroma prediction block of the plurality of chroma prediction blocks based on a cross-component prediction mode in which the second chroma prediction block is derived based on reconstructed luma samples of the luma block; and
determining a prediction block of the chroma block as a weighted average of the first chroma prediction block and the second chroma prediction block.

2. The method of claim 1, wherein the cross-component prediction mode includes one of:
a first cross-component prediction mode in which the second chroma prediction block is derived based on the reconstructed luma samples of the luma block that are filtered according to filter coefficients of a first filter, the filter coefficients of the first filter being derived based on a chroma prediction of the chroma block and a luma prediction of the luma block, and
a second cross-component prediction mode in which the second chroma prediction block is derived based on the reconstructed luma samples of the luma block that are filtered by filter coefficients of a second filter, the filter coefficients of the second filter being derived based on a merge candidate in a merge list.

3. The method of claim 1, wherein the first syntax element is signaled in the bitstream when the cross-component prediction mode is applied to the current block.

4. The method of claim 1, further comprising:
determining a prediction block of the luma block by copying a luma inter-prediction block when the first syntax element indicates that the chroma block is predicted by the weighted average of the plurality of chroma prediction blocks and the cross-component prediction mode is applied to the current block.

5. The method of claim 1, further comprising:
receiving a flag in the bitstream, the flag indicating whether the luma block is predicted using a weighted average of a plurality of luma prediction blocks.

6. The method of claim 1, wherein:
when both a top neighboring block and a left neighboring block of the current block are coded in the cross-component prediction mode, a weight of the second chroma prediction block in the weighted average is 0.75,
when one of the top neighboring block and the left neighboring block of the current block is coded in the cross-component prediction mode, the weight of the second chroma prediction block in the weighted average is 0.5, and
when none of the top neighboring block and the left neighboring block of the current block is coded in the cross-component prediction mode, the weight of the second chroma prediction block in the weighted average is 0.25.

7. The method of claim 2, further comprising:
constructing the merge list based on a plurality of cross-component prediction coded blocks that includes at least one of (i) an adjacent spatial neighboring block, (ii) a non-adjacent spatial neighboring block, (iii) a history-based neighboring block, (iv) a temporal collocated block, and (v) a temporal shifted block in a reference picture of the current picture, the merge list being constructed based on a predefined scanning order of the adjacent spatial neighboring block, the history-based neighboring block, the non-adjacent spatial neighboring block, and the temporal collocated block from the reference picture.

8. The method of claim 1, further comprising:
when a second syntax element in the bitstream indicates that a merge list is used in the cross-component prediction mode, determining a merge candidate from the merge list that is indicated by an index in the bitstream.

9. The method of claim 2, further comprising:
when a second syntax element indicates that the second cross-component prediction mode is not applied,
deriving the filter coefficients of the first filter based on the chroma prediction of the chroma block and the luma prediction of the luma block, or
determining the filter coefficients of the first filter according to signaled information in the bitstream.

10. The method of claim 2, further comprising:
dividing the merge list into a plurality of sub-groups; and
determining the merge candidate from the merge list that is indicated by an index in the bitstream, the index including a first part indicating which one of the plurality of sub-groups is selected and a second part indicating which one of merge candidates is selected from the selected sub-group.

11. A method of video encoding, the method comprising:
determining (i) a first chroma prediction block of a chroma block of a current block in a current picture based on an inter prediction mode and (ii) a second chroma prediction block of the chroma block of the current block based on a cross-component prediction mode in which the second chroma prediction block is derived based on reconstructed luma samples of a luma block of the current block;
determining a prediction block of the chroma block as a weighted average of the first chroma prediction block of a plurality of chroma prediction blocks and the second chroma prediction block of the plurality of chroma prediction blocks; and
encoding a first syntax element in a bitstream that indicates the chroma block of the current block is predicted by the weighted average of the plurality of chroma prediction blocks.

12. The method of claim 11, wherein the cross-component prediction mode includes one of:
a first cross-component prediction mode in which the second chroma prediction block is derived based on the reconstructed luma samples of the luma block that are filtered according to filter coefficients of a first filter, the filter coefficients of the first filter being derived based on a chroma prediction of the chroma block and a luma prediction of the luma block, and
a second cross-component prediction mode in which the second chroma prediction block is derived based on the reconstructed luma samples of the luma block that are filtered by filter coefficients of a second filter, the filter coefficients of the second filter being derived based on a merge candidate in a merge list.

13. The method of claim 11, wherein the first syntax element is encoded in the bitstream when the cross-component prediction mode is applied to the current block.

14. The method of claim 11, further comprising:
determining a prediction block of the luma block by copying a luma inter-prediction block when the first syntax element indicates that the chroma block is predicted by the weighted average of the plurality of chroma prediction blocks and the cross-component prediction mode is applied to the current block.

15. The method of claim 11, further comprising:
encoding a flag in the bitstream, the flag indicating whether the luma block is predicted using a weighted average of a plurality of luma prediction blocks.

16. The method of claim 11, wherein:
when both a top neighboring block and a left neighboring block of the current block are coded in the cross-component prediction mode, a weight of the second chroma prediction block in the weighted average is 0.75,
when one of the top neighboring block and the left neighboring block of the current block is coded in the cross-component prediction mode, the weight of the second chroma prediction block in the weighted average is 0.5, and
when none of the top neighboring block and the left neighboring block of the current block is coded in the cross-component prediction mode, the weight of the second chroma prediction block in the weighted average is 0.25.

17. The method of claim 12, further comprising:
constructing the merge list based on a plurality of cross-component prediction coded blocks that includes at least one of (i) an adjacent spatial neighboring block, (ii) a non-adjacent spatial neighboring block, (iii) a history-based neighboring block, (iv) a temporal collocated block, and (v) a temporal shifted block in a reference picture of the current picture, the merge list being constructed based on a predefined scanning order of the adjacent spatial neighboring block, the history-based neighboring block, the non-adjacent spatial neighboring block, and the temporal collocated block from the reference picture.

18. The method of claim 11, further comprising:
encoding a second syntax element in the bitstream, the second syntax element indicating that a merge list is used in the cross-component prediction mode; and
encoding an index in the bitstream when the second syntax element is encoded, the index indicating a merge candidate that is determined from the merge list.

19. The method of claim 12, further comprising:
when the second cross-component prediction mode is not applied,
deriving the filter coefficients of the first filter based on the chroma prediction of the chroma block and the luma prediction of the luma block, or
determining the filter coefficients of the first filter according to signaled information in the bitstream.

20. A non-transitory computer-readable storage medium storing instructions which when executed by a processor cause the processor to perform an encoding method comprising:
determining (i) a first chroma prediction block of a chroma block of a current block in a current picture based on an inter prediction mode and (ii) a second chroma prediction block of the chroma block of the current block based on a cross-component prediction mode in which the second chroma prediction block is derived based on reconstructed luma samples of a luma block of the current block;
determining a prediction block of the chroma block as a weighted average of the first chroma prediction block of a plurality of chroma prediction blocks and the second chroma prediction block of the plurality of chroma prediction blocks;
encoding a first syntax element in a bitstream that indicates the chroma block of the current block is predicted by the weighted average of the plurality of chroma prediction blocks; and
transmitting the encoded bitstream.
